(19) United States
(12) Patent Application Publication
(10) Pub. No.: US 2022/0357897 A1
(43) Pub. Date: Nov. 10, 2022

(54) SCALABLE CONTENT DELIVERY RESOURCE USAGE

(71) Applicant: RAKUTEN MOBILE, INC., Tokyo (JP)

(72) Inventors: Tarun BHARDWAJ, Karnataka (IN); Devesh GAUTAM, Tokyo (JP)

(21) Appl. No.: 17/456,360

(22) Filed: Nov. 23, 2021

Related U.S. Application Data
(60) Provisional application No. 63/186,033, filed on May 7, 2021.

(51) Int. Cl. G06F 3/06; G06F 9/455

(52) U.S. Cl. CPC G06F 3/0664; G06F 3/0604; G06F 3/067; G06F 9/45558

(57) ABSTRACT

Scalable content delivery resource usage is performed by operations including provisioning an initial edge virtualization provisioned with an allocation of local resources and an edge application. The operations further include provisioning additional edge virtualizations in response to an increase in concurrent data requests. The operations may further include provisioning an initial storage virtualization provisioned with an allocation of the local resources and a storage application. The operations further include provisioning an additional storage virtualization in response to an increase in data on the local resources.

### PRIORITY CLAIM AND CROSS-REFERENCE

This application claims priority to Provisional Application No. 63/186,033, filed May 7, 2021, which is hereby incorporated by reference in its entirety.

### BACKGROUND

To provide digital content to different devices throughout a broad area network, such as the Internet, a geographically distributed group of servers at edges and/or intermediary locations of the network are used to cache the digital content to reduce the workload of the content source or origin. Such a group of servers may be referred to as a Content Delivery Network (CDN).

A CDN may been introduced to deploy servers acting as an origin server from a network location much closer to the devices. A CDN may also save transportation and network service providing costs, because each server delivers the content from an edge location in the network instead of the origin. Thereby, an overload of requests to the origin can be avoided. In contrast to providing content from the origin, which must receive and respond to requests from much farther across the network, a CDN provides low-latency access to media content and increased Quality of Service (QoS). In turn, this may increase user engagement and time spent on any content-providing websites, apps, channels, etc.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for scalable content delivery resource usage, according to at least one embodiment of the present invention.

FIG. 2 is an operational flow for scalable content delivery resource usage, according to at least one embodiment of the present invention.

FIG. 3 is an operational flow for scaling an edge layer, according to at least one embodiment of the present invention.

FIG. 4 is an operational flow for scaling a storage layer, according to at least one embodiment of the present invention.

FIG. 5 is a block diagram of an allocation of resources of a network server, according to at least one embodiment of the present invention.

FIG. 6 is an operational flow for content delivery, according to at least one embodiment of the present invention.

FIG. 7 is an operational flow for content retrieval, according to at least one embodiment of the present invention.

FIG. 8 is an operational flow for unrequested data removal, according to at least one embodiment of the present invention.

FIG. 9 is a block diagram of an exemplary hardware configuration for scalable content delivery resource usage, according to at least one embodiment of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In at least one example of a CDN, by using high-performance caching reverse proxy software, the CDN is able to control how, when, where and to whom content providers deliver digital content, while reducing traffic load to the origin. This works by caching the requested content. More specifically, every time a new request for content (web page, image, video segment, etc.) is fetched by a server from the origin, the new request is stored (or cached) in the server for use in subsequent deliveries without spending resources contacting the origin.

Ideally, a CDN should accept all device connections so that no devices rely on the origin, and each server within the CDN should store all requested content, so that content is only requested from the origin once, and never again, not even after 30 days of the request.

To accept device connections, a certain amount of processing power and storage is utilized by each server, and more local storage is better for delivering content than external storage. If the amount of concurrent device connections is low, then not as much processing power and storage is utilized. Ideally, any excess computational resources would be turned off or diverted to other operations. In a CDN server that operates as a virtual machine or native operating system, removing or diverting resources is inefficient or not possible. However, by utilizing a cloud native approach, excess resources can be easily removed or diverted. By utilizing containers or other types of scalable virtualizations, resources for accepting device connections are able to be decoupled from resources for storing content, and therefore are individually scalable.

In a cloud native approach, processing and storage resources are able to be reduced at off peak time, such as by turning excess resources off or diverting the excess resources to other applications, which may reduce total energy expenditure. The cloud native approach may allow utilization of features like autoscaling, which helps to reduce overprovisioning of computational resources.

In some embodiments, each CDN server operates with a two-tier architecture. The two tiers, which are referred to as “edge” and “storage” in some embodiments, include one or more virtualizations, such as containers, the number of which will scale up and down depending on the need. The two layers can scale independent of each other.

In some embodiments for providing website content, the edge layer is configured to serve Hyper-Text Transfer Protocol (HTTP) requests while implementing Web Application Firewall (WAF), Transport Layer Security (TLS), Cache, etc., and the storage layer is configured to retrieve media content from the respective Origin.

The edge layer is able to expand based upon traffic. For example, each virtualization in the edge layer is able to handle approximately 3,000 concurrent devices. If device concurrency is 15,000, then 5 edge virtualizations would be running. If device concurrency is less than 3,000, such as during off peak time, then only one edge virtualization will run.

The storage layer can expand based on content demand in terms of both size and recency, For example, in some embodiments each virtualization in the storage layer is able to hold 2 terabytes of data. The storage layer, which is allocated local storage, only locally stores data which has been accessed within the last seven days. After that, the storage layer will move unrequested data to external storage, which is more energy efficient than local storage. If the amount of data requested in the last seven days is 10 terabytes, then 5 storage virtualizations would be running.

Within the storage layer of some embodiments, each virtualization is allocated both volatile memory, such as RAM, and non-volatile memory, such as SSD. In some embodiments, the storage layer is configured with separate holding policies for each type of memory based on request recency. For example, dynamic content and static content that has been accessed in the last two hours may be labeled HOT data. Static content that has been accessed in the last seven days may be labeled WARM data. In some embodiments, static content that has not been accessed in the last seven days is labeled COLD data. HOT data will reside on the volatile local storage, WARM data will reside on the non-volatile local storage, and COLD data will reside on the external storage.

In some embodiments, the storage layer is also configured with separate eviction policies that complement the holding policies. For example, content that is accessed for the first time is retrieved from the origin and stored in the volatile memory, where the content will remain during transmission to the requesting device(s), and also stored in parallel in the non-volatile memory. The content will remain in the volatile memory for another two hours, and then, if not accessed within two hours, will be removed from the volatile memory, while the parallel storage of the content in the non-volatile memory is maintained. Then, if the content is not accessed within seven days, the content will be moved from the non-volatile local storage to external storage. In some implementations, the content is removed from the external storage after thirty days, meaning that the content would be retrieved from the origin upon future request. In some implementations, the content remains on the external storage indefinitely.

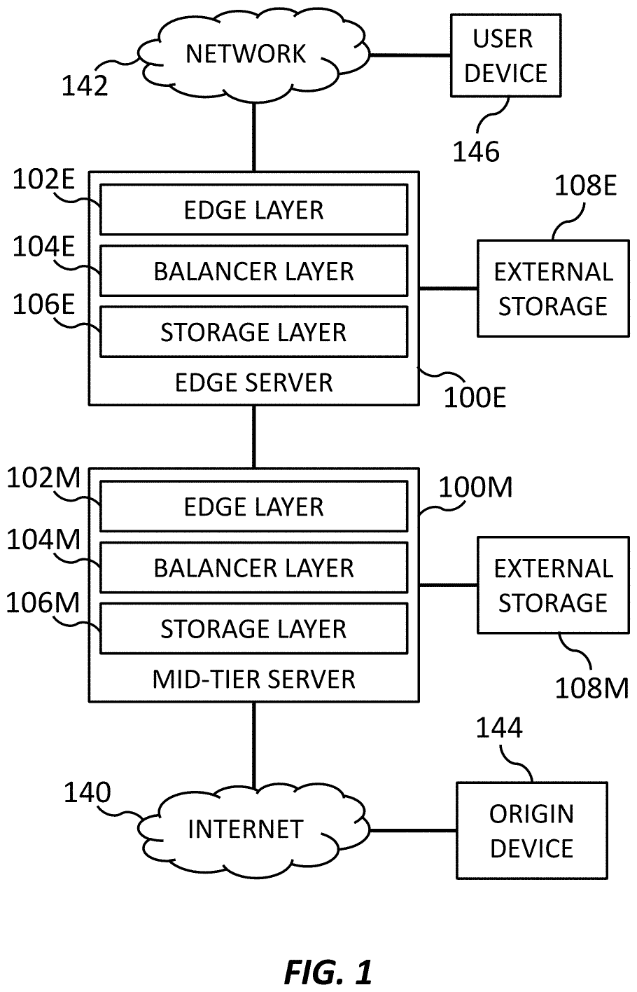

FIG. 1 is a schematic diagram of a system for scalable content delivery resource usage, according to at least one embodiment of the present invention. The system includes an edge server 100E, a mid-tier server 100M, external storage 108E, external storage 108M, an internet 140, a provider network 142, an origin device 144, and a user device 146.

Edge server 100E has a network location that is closer to user device 146 than mid-tier server 100M or origin device 144, and is within provider network 142, in some embodiments. In some embodiments, edge server 100E is a host server that executes an on-premise operating system that hosts virtualizations provisioned by client computers, such as a cloud native environment. Such virtualizations are in the form of virtual machines, containers, or any other layer of execution between the bare-metal operating system or hypervisor and applications of client computers. Among the virtualizations hosted on edge server 100E are edge virtualizations, balancer virtualizations, and storage virtualizations. In some embodiments, the virtualizations are containers, which share a common host kernel but have individual resource allocations. In some embodiments, other types of virtualizations may be used. The containers form groups, or layers, based on application. The layers include edge layer 102E, balancer layer 104E, and storage layer 106E.

Edge layer 102E is a group of one or more instances of edge virtualization. Each edge virtualization is provisioned with an allocation of local resources of edge server 100E and an edge application. Balancer layer 104E is a group of one or more instances of balancer virtualization. Each balancer virtualization is provisioned with an allocation of local resources of edge server 100E and a balancer application. Storage layer 106E is a group of one or more instances of storage virtualization. Each storage virtualization is provisioned with an allocation of local resources of edge server 100E and a storage application. At least the storage application is operable to interact with external storage 108E. In some embodiments, external storage 108E includes another server, computer, or other device configured to store data. In some embodiments, external storage 108E is within provider network 142. In some embodiments, external storage 108E is in communication with edge server 100E through internet 140, or directly connected to edge server 100E. The edge applications, balancer applications, and storage applications of edge server 100E respond to requests for content from user device 146 by delivering the requested content to user device 146, and retrieve requested content from origin device 144 only when requested.

Mid-tier server 100M is located between origin device 144 and edge server 100E. In some embodiments, mid-tier server 100M is within provider network 142 or internet 140, and near the boundary between provider network 142 and internet 140. Mid-tier server 100M is substantially similar to edge server 100E. The foregoing description of the structure and function of edge server 100E is also applicable to mid-tier server 100M, except where distinguished. The layers of mid-tier server 100M include edge layer 102M, balancer layer 104M, and storage layer 106M. The edge applications, balancer applications, and storage applications of mid-tier server 100M respond to requests for content from either user device 146 or edge server 100E by delivering the requested content to user device 146 or edge server 100E, respectively, and retrieve requested content from origin device 144 only when necessary. Because the applications of mid-tier server 100M are configured to respond to requests from both user device 146 and edge server 100E, mid-tier server 100M may have significantly more computational resources than edge server 100E. External storage 108M is substantially similar to external storage 108E in structure and function. In some embodiments, each of edge server 100E and mid-tier server 100M have dedicated external storage, while in some other embodiments edge server 100E and mid-tier server 100M share external storage.

Internet 140 is a wide area network, such as the Internet, that connects many different provider networks in some embodiments. Provider network 142 is a network designed to provide many different user devices access to internet 140. In some embodiments, provider network 142 has many access points throughout a geographic area, each supporting one or more communication standards so that many different types of user devices are able to connect. User device 146 is a device operated by a user or group of users that requests content from origin device 144. In some embodiments, user device 146 includes a device having limited computational resources, such as smart watches, fitness trackers, Internet-of-Things (IoT) devices, etc., or a device having computational resources for a broader range of capabilities, such as smart phones, tablets, personal computers, etc. User device 146 could also include a server or mainframe similar to edge server 100E.

Origin device 144 is a device that operates as the source providing content requested by many different user devices, such as user device 146. In some embodiments, origin device 144 is a server having a direct connection to internet 140. However, in some embodiments, origin device 144 is considered a user device, in that origin device 144 is a personal computer, server, or mainframe that connects to internet 140 through a provider network, such as provider network 142. Origin device 144 is configured to generally respond to requests for content. Because of the configuration of the content delivery system in some embodiments, the only requests for content that actually reach origin device 144 are those from edge-tier server 100E and mid-tier server 100M when the requested content is not already stored. All requests for content from user device 146 are intercepted and handled by edge server 100E.

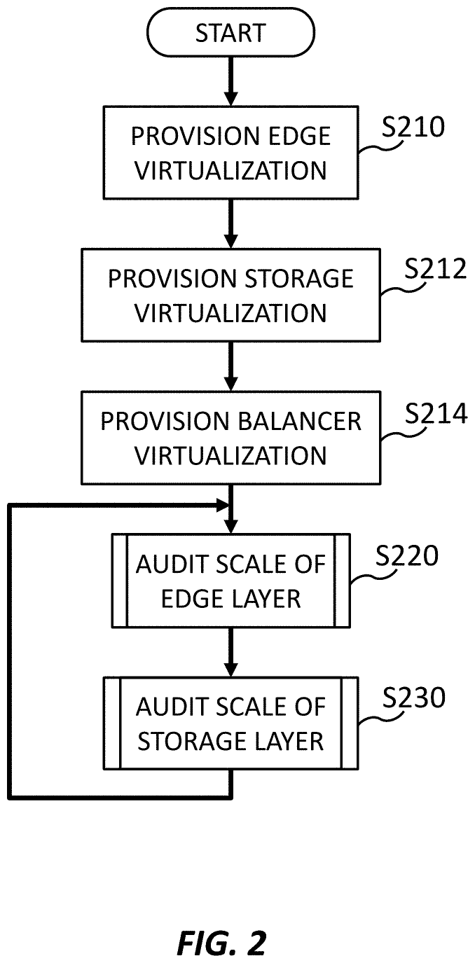

FIG. 2 is an operational flow for scalable content delivery resource usage, according to at least one embodiment of the present invention. The operational flow provides a method of scaling content delivery resource usage by an apparatus in communication with a host server.

At S210, a provisioning section provisions one or more edge virtualizations in an edge layer on the host server. For example, in some embodiments, the provisioning section provisions an initial edge virtualization among a plurality of edge virtualizations, each edge virtualization of the plurality of edge virtualizations provisioned with an allocation of local resources and an edge application. In some embodiments, the provisioning section configures the edge application to receive data requests from at least one device, retrieve requested data from a plurality of storage virtualizations, and transmit the requested data to the at least one device.

At S212, the provisioning section provisions one or more storage virtualizations in a storage layer on the host server. For example, in some embodiments, the provisioning section provisions an initial storage virtualization among a plurality of storage virtualizations, each storage virtualization of the plurality of storage virtualizations provisioned with an allocation of local resources and a storage application. In some embodiments, the provisioning section configures the storage application to receive data requests from the plurality of edge virtualizations, receive, in the allocation of the local resources, the requested data from an origin device in response to the requested data being unavailable on the local resources, and remove unrequested data from the allocation of the local resources, the unrequested data being data that has not been requested for a period of time.

At S214, the provisioning section provisions one or more balancer virtualizations in a balancer layer on the host server. For example, in some embodiments, the provisioning section provisions an initial balancer virtualization among a plurality of balancer virtualizations, each balancer virtualization of the plurality of balancer virtualizations is provisioned with an allocation of local resources and a balancer application. In some embodiments, the provisioning section configures the balancer application to direct communication between the plurality of edge virtualizations and the plurality of storage virtualizations.

At S220, a scaling section audits the scale of the edge layer on the host. For example, in some embodiments, the scaling section determines whether a number of edge virtualizations among the plurality of edge virtualizations is proportional to a number of concurrent data requests. In some embodiments, the scaling section causes the provisioning section to add or remove edge virtualizations in order to maintain a designated proportion.

At S230, the scaling section audits the scale of the storage layer on the host server. For example, in some embodiments, the scaling section determines whether a number of storage virtualizations among the plurality of storage virtualizations is proportional to an amount of data stored in the local resources. In some embodiments, the scaling section causes the provisioning section to add or remove storage virtualizations in order to maintain a designated proportion.

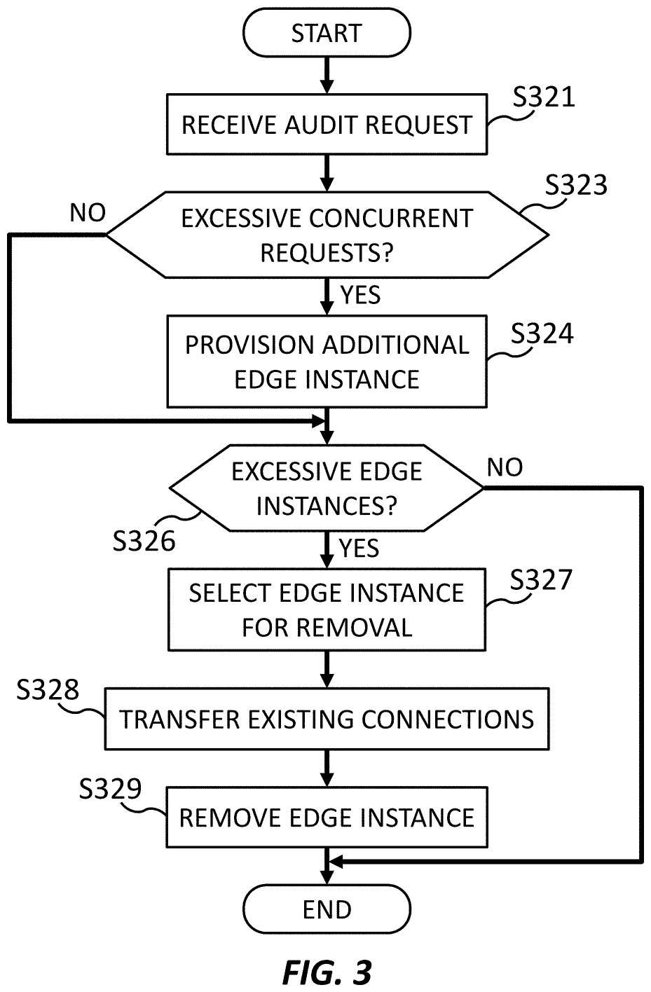

FIG. 3 is an operational flow for scaling an edge layer, according to at least one embodiment of the present invention. In some embodiments, the operational flow provides a method of scaling the edge layer of a host server by a scaling section or a correspondingly named sub-section thereof of an apparatus in communication with the host server.

At S321, the scaling section receives an audit request to check the scale of the edge layer. For example, in some embodiments, an audit request is received from the host server or another section of the apparatus, and is in response to an event, an amount of time elapsing since the previous audit, etc. Receiving the audit request initiates the operational flow of FIG. 3.

At S323, the scaling section examines the number of concurrent data requests from user devices among all edge virtualizations in the edge layer and the number of edge virtualizations, to determine whether the number of concurrent requests is excessive in comparison to the number of edge virtualizations. For example, in some embodiments, the scaling section determines whether a limit per instance of edge virtualization has been exceeded. If the scaling section determines that the number of concurrent requests is excessive, then the operational flow proceeds to S324 to provision an additional instance of edge virtualization. If the scaling section determines that the number of concurrent requests is not excessive, then the operational flow proceeds to S326 without provisioning an additional instance of edge virtualization.

At S324, a provisioning section of the apparatus provisions an additional instance of edge virtualization for the edge layer. For example, in some embodiments, if an increase in concurrent data requests causes the number of concurrent data requests to become excessive, then the scaling section causes the provisioning section to provision an additional instance of edge virtualization for the edge layer in response to the increase in concurrent data requests. In some embodiments, the provisioning section provisions multiple additional instances of edge virtualization depending on the excessiveness of the number of concurrent requests. In some embodiments where audits are requested less frequently, provisioning multiple additional instances of edge virtualization are more common. In some embodiments, the scaling section causes the provisioning section to provision one or more additional edge virtualizations among the plurality of edge virtualizations so that a number of edge virtualizations among the plurality of edge virtualizations is proportional to a number of concurrent data requests.

At S326, the scaling section examines the number of concurrent data requests from user devices among all edge virtualizations in the edge layer and the number of edge virtualizations, but unlike at S323 to determine whether the number of edge virtualizations is excessive in comparison to the number of concurrent requests. For example, in some embodiments, the scaling section determines whether a limit per instance of edge virtualization would be exceeded if one instance of edge virtualization is removed. If the scaling section determines that the number of edge virtualizations is excessive, then the operational flow proceeds to S327 to begin operations for removing an instance of edge virtualization. If the scaling section determines that the number of edge virtualizations is not excessive, then the operational ends without removing an instance of edge virtualization.

At S327, the scaling section selects an instance of edge virtualization for removal. For example, in some embodiments, the scaling section selects an edge virtualization having the smallest number of active connections to user devices or using the smallest amount of bandwidth among the plurality of edge virtualizations in the edge layer. Criteria for selection of the instance of edge virtualization for removal varies depending on design preferences. In some embodiments, the criteria are age-related, or depend on multiple weighted factors. In some embodiments, the scaling section selects multiple instances of edge virtualization for removal depending on the excessiveness of the number of edge virtualizations.

At S328, the scaling section transfers the existing connections of the instance of edge virtualization selected for removal at S327 to one or more other instances of edge virtualization among the plurality of edge virtualizations in the edge layer. In some embodiments, the existing connections are divided among multiple instances of edge virtualization, even when only one instance is being removed.

At S329, once all of the existing connections have been transferred, the scaling section removes the instance of edge virtualization selected for removal at S327. In doing so, the computational resources allocated to the removed instance of edge virtualization are freed for other use, such as allocation of other instances of virtualization from the apparatus or other client computers, or other functions of the host server outside of client operations. In some embodiments, the scaling section removes one or more additional edge virtualizations among the plurality of edge virtualizations so that a number of edge virtualizations among the plurality of edge virtualizations is proportional to the number of concurrent data requests.

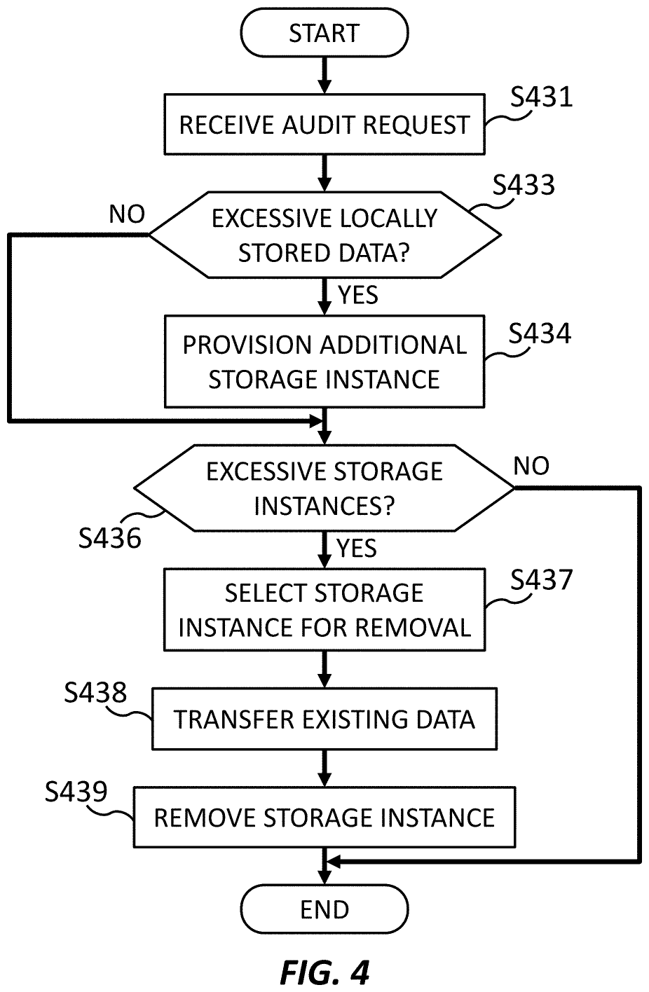

FIG. 4 is an operational flow for scaling a storage layer, according to at least one embodiment of the present invention. In some embodiments, the operational flow provides a method of scaling the storage layer of a host server by a scaling section or a correspondingly named sub-section thereof of an apparatus in communication with the host server.

At S431, the scaling section receives an audit request to check the scale of the storage layer. For example, in some embodiments, an audit request is received from the host server or another section of the apparatus, and is in response to an event, an amount of time elapsing since the previous audit, etc. In some embodiments, the audit request to check the scale of the storage layer is separate from the audit request to check the scale of the edge layer, or a combined request is received. Receiving the audit request initiates the operational flow of FIG. 4.

At S433, the scaling section examines the amount of stored data among all storage virtualizations in the storage layer, which are referred to as locally stored data in some instances, and the number of storage virtualizations, to determine whether the amount of stored data is excessive in comparison to the number of storage virtualizations. For example, in some embodiments, the scaling section determines whether a limit per instance of storage virtualization has been exceeded. If the scaling section determines that the amount of stored data is excessive, then the operational flow proceeds to S434 to provision an additional instance of storage virtualization. If the scaling section determines that the amount of stored data is not excessive, then the operational flow proceeds to S436 without provisioning an additional instance of storage virtualization.

At S434, a provisioning section of the apparatus provisions an additional instance of storage virtualization for the storage layer. For example, in some embodiments, if an increase in locally stored data causes the amount of data on the local resources to become excessive, then the scaling section causes the provisioning section to provision an additional instance of storage virtualization for the storage layer in response to the increase in data on the local resources. In some embodiments, the provisioning section provisions multiple additional instances of storage virtualization depending on the excessiveness of the locally stored data. In some embodiments where audits are requested less frequently, provisioning multiple additional instances of storage virtualization are more common than in some embodiments where audits are requested more frequently. In some embodiments, the scaling section causes the provisioning section to provision one or more additional storage virtualizations among the plurality of storage virtualizations so that a number of storage virtualizations among the plurality of storage virtualizations is proportional to the amount of data stored in the local resources.

At S436, the scaling section examines the amount of locally stored data and the number of storage virtualizations, but unlike at S433 to determine whether the number of storage virtualizations is excessive in comparison to the amount of locally stored data. For example, in some embodiments, the scaling section determines whether a limit per instance of storage virtualization would be exceeded if one instance of storage virtualization is removed. If the scaling section determines that the number of storage virtualizations is excessive, then the operational flow proceeds to S437 to begin operations for removing an instance of storage virtualization. If the scaling section determines that the number of storage virtualizations is not excessive, then the operational flow ends without removing an instance of storage virtualization.

At S437, the scaling section selects an instance of storage virtualization for removal. For example, in some embodiments, the scaling section selects a storage virtualization storing the smallest amount of data. Criteria for selection of the instance of storage virtualization for removal vary depending on design preferences. In some embodiments, the criteria is age-related, or depend on multiple weighted factors. In some embodiments, the scaling section selects multiple instances of storage virtualization for removal depending on the excessiveness of the number of storage virtualizations.

At S438, the scaling section transfers the existing data of the instance of storage virtualization selected for removal at S437 to one or more other instances of storage virtualization among the plurality of storage virtualizations in the storage layer. In some embodiments, the existing data is divided, at least on a content-by-content basis, among multiple instances of storage virtualization, even when only one instance is being removed.

At S439, once all of the existing connections have been transferred, the scaling section removes the instance of storage virtualization selected for removal at S437. In doing so, the computational resources allocated to the removed instance of storage virtualization are freed for other use, such as allocation of other instances of virtualization from the apparatus or other client computers, or other functions of the host server outside of client operations. In some embodiments, the scaling section removes one or more additional storage virtualizations among the plurality of storage virtualizations so that a number of storage virtualizations among the plurality of storage virtualizations is proportional to the amount of data stored in the local resources.

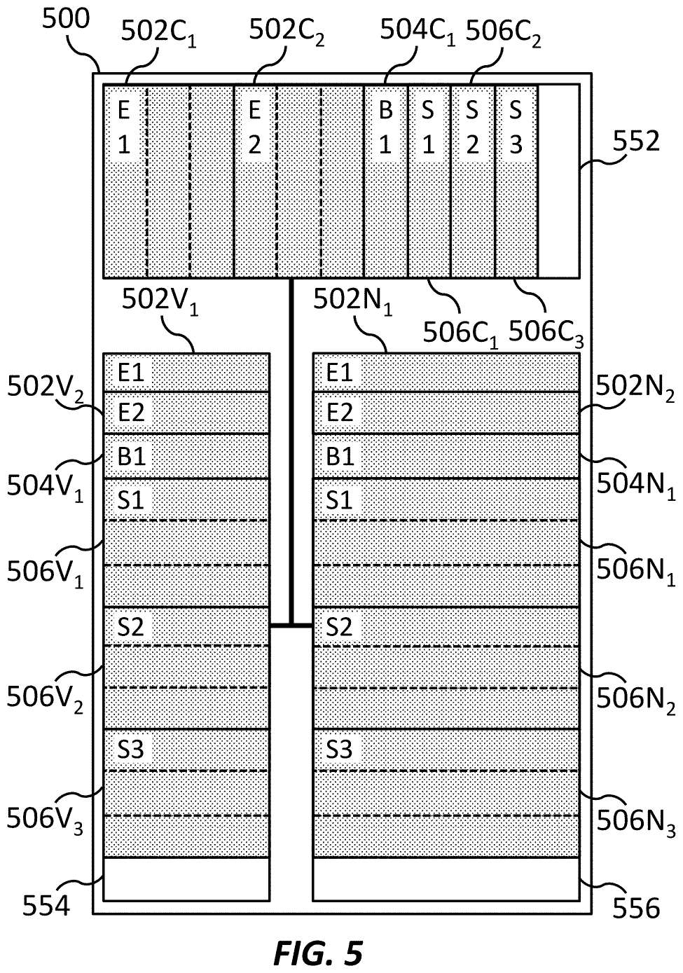

FIG. 5 is a block diagram of an allocation of resources of a host server 500, according to at least one embodiment of the present invention. In some embodiments, host server 500 hosts virtualizations provisioned by multiple client computers for different purposes, where content delivery may be just one purpose of one client computer. Each virtualization provisioned by a client computer receives an allocation of local resources, including a portion of computational resources of host server 500. The computational resources of host server 500 include processing cores 552, volatile memory 554, and non-volatile memory 556.

In some embodiments, processing cores 552 include one or more processors including one or more cores. In some embodiments, the processors have fewer cores for performing many types of logical computations, such as central processing units, or have many cores for performing a specific type of logical computation, such as graphical processing units. In some embodiments, volatile memory 554 includes Random Access Memory (RAM), such as dynamic RAM, static RAM, etc., and also includes any on-chip memory of processing cores 552. In some embodiments, non-volatile memory 556 includes drive memory, such as hard disk drives and solid state drives, or flash memory, such as NOR flash and NAND flash. As shown in FIG. 5, each of processing cores 552, volatile memory 554, and non-volatile memory 556 is apportioned. Although only a few portions are shown, this is for simplicity. In an actual host server environment, the apportionment is much finer, in some embodiments. The amount of each resource that is allocated to a virtualization depends on the specifications of that virtualization.

Each of the two edge virtualization instances, E1 and E2, is allocated three portions of processing cores 552, allocation 502C₁ and allocation 502C₂, but only one portion of volatile memory 554, allocation 502V₁ and allocation 502V₂, and only one portion of non-volatile memory 556, allocation 502N₁ and allocation 502N₂. This is because the operations performed by the edge layer utilize more processing power, and less memory.

Each of the three storage virtualization instances, S1, S2, and S3, is allocated only one portion of processing cores 552, allocation 506C₁, allocation 506C₂, and allocation 506C₃, but three portions of volatile memory 554, allocation 506V₁, allocation 506V₂, and allocation 506V₃, and three portions of non-volatile memory 556, allocation 506N₁, allocation 506N₂, and allocation 506N₃. This is because the operations performed by the storage layer utilize less processing power, and more memory.

There is only one balancer virtualization instance, B1, which is allocated only one portion of processing cores 552, allocation 504C₁, only one portion of volatile memory 554, allocation 504V₁, and only one portion of non-volatile memory 556, allocation 504N₁. This is because the operations performed by the balancer layer may not utilize much processing power or memory.

In some embodiments, a host server has more or less types of resources to allocate, ranging from typical resources, such as processing and memory, to more specialized resources, such as specialized chips having proprietary functions. In some embodiments, within processing and memory, allocations are made based on the individual type. For example, in some embodiments, central processing unit cores are allocated separately from graphics processing unit cores. Although FIG. 5 appears to include a small number of virtualizations allocated nearly all of the resources, this is only for simplicity. An actual host server has enough resources to host millions of virtualizations of similar resource usage, in some embodiments. From the perspective of an apparatus provisioning the content delivery layers, the host server has a seemingly unlimited amount of resources, allowing the apparatus to focus more on content delivery and energy consumption, without being concerned about a resource usage limit.

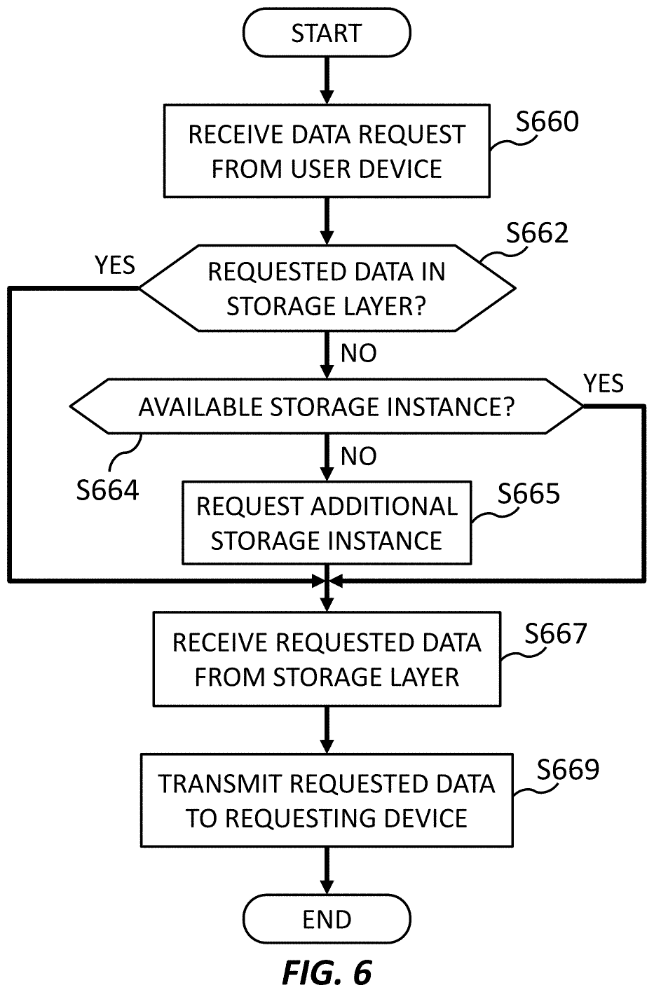

FIG. 6 is an operational flow for content delivery, according to at least one embodiment of the present invention. In some embodiments, the operational flow provides a method of content delivery to a user device by an edge application of an edge virtualization in an edge layer of a host server.

At S660, the edge application receives a request for digital content from a user device. For example, in some embodiments, the user device enters an address or follows a link to digital content on an origin device. However, instead of the origin device receiving the request, the edge application intercepts the request. In some embodiments, the request is an HTTP request, and the edge application may perform reverse HTTP proxy to intercept the request. In some embodiments, the digital content is identified in the request by a specific address on the origin device or other identifier.

At S662, the edge application communicates with the storage layer to determine whether any of the storage virtualizations in the storage layer are currently storing the requested data. If the requested data is currently stored in the storage layer, then the operational flow proceeds to S667 to receive the requested data from the storage layer. If the requested data is not currently stored in the storage layer, then the operational flow proceeds to S664 to find a suitable instance of storage virtualization for retrieval of the requested data.

At S664, the edge application determines whether the storage layer currently includes an instance of storage virtualization that has enough free memory to store the requested data. If the storage layer currently includes an instance of storage virtualization that has enough free memory to store the requested data, then the operational flow proceeds to S667 to receive the requested data from the storage layer. If the storage layer does not currently include any instance of storage virtualization that has enough free memory to store the requested data, then the operational flow proceeds to S665 to request an additional instance of storage virtualization.

At S665, the edge application requests an additional instance of storage virtualization for the storage layer. For example, in some embodiments, the request for an additional instance of storage virtualization is in the form of an audit request, such as operation S431 in FIG. 4, which results in the provision of multiple additional instances of storage virtualization, or is a more direct request for a single additional instance of storage virtualization.

At S667, the edge application receives the requested data from the storage layer. For example, in some embodiments, the instance of storage virtualization currently storing the requested data identified at operation S662 transmits the requested data to the edge application. In some embodiments, the existing and available instance of storage virtualization identified at operation S664, or the additional instance of storage virtualization requested at operation S 665, retrieves the requested data from an external storage or from the origin server, and then transmit the requested data to the edge application.

At S669, the edge application transmits the requested data to the requesting user device. For example, in some embodiments, the edge application forwards the requested data as the requested data is received from the instance of storage virtualization at S667.

In some embodiments, the edge application performs all of the operations. However, in some other embodiments, a balancer layer performs one or more operations, such as operations S662, S664, and S665. Some embodiments that implement a balancer layer to direct communication between the edge layer and the storage layer reduce the workload on each instance of edge virtualization in the edge layer, which helps to improve the overall efficiency of content delivery. In some embodiments, the storage layer performs operations S662, S664, and S665. Such flexibility in the layer design allows increased efficiency depending on the type of content being delivered, the popularity of the content, etc.

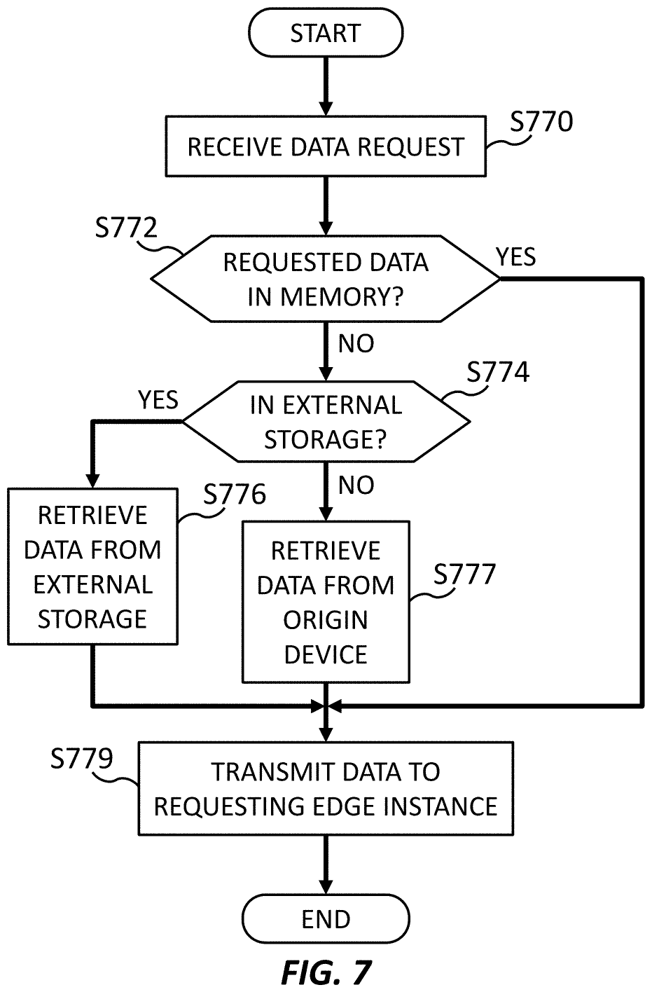

FIG. 7 is an operational flow for content retrieval, according to at least one embodiment of the present invention. In some embodiments, the operational flow provides a method of content retrieval by a storage application of a storage virtualization in a storage layer of a host server.

At S770, the storage application receives a request for digital content. For example, in some embodiments the storage application receives the request from an edge layer of the host server as a result of one of operations S662, S664, and S665 of FIG. 6. In some embodiments, the storage application receives the request from a balancer layer of the host server.

At S772, the storage application determines whether the requested data is currently stored in the allocated resources of the instance of storage virtualization running the storage application. For example, if the request was received as a result of operation S662 of FIG. 6, then the requested data is likely currently stored in the allocated resources. If the storage application determines that the requested data is currently stored in the allocated resources, then the operational flow proceeds to S779 to transmit the requested data. If the storage application determines that the requested data is currently stored in the allocated resources, then the operational flow proceeds to S774 to determine a source of retrieval.

At S774, the storage application determines whether the requested data is currently stored in an external storage in communication with the host server. For example, if the requested data was once retrieved from the origin device, but was not requested for a significant amount of time, then a chance that the requested data has been moved to the external storage increases. If the storage application determines that the requested data is currently stored in the external storage, then the operational flow proceeds to S776 to retrieve the requested data. If the storage application determines that the requested data is not currently stored in the external storage, then the operational flow proceeds to S777 to retrieve the requested data.

At S776, the storage application retrieves the requested data from the external storage. For example, the storage application moves the requested data from the external storage to the allocated resources of the instance of storage virtualization running the storage application. In other words, the storage application is configured to receive, in the allocation of the local resources, the requested data from the external storage in response to the requested data being unavailable on the local resources and available in the external storage. In some embodiments, the storage application copies the requested data from the external storage to the allocated resources, maintaining a copy on the external storage.

At S777, the storage application retrieves the requested data from the origin device. For example, the storage application copies the requested data from the origin device to the allocated resources of the instance of storage virtualization running the storage application, maintaining a copy on the external storage.

At S779, once the requested data is stored in the allocated resources of the instance of storage virtualization running the storage application, the storage application may transmit the requested data to the edge layer. More specifically, in some embodiments, the storage application transmits the requested data to the instance of edge virtualization running the requesting edge application. In some embodiments where the storage virtualization is allocated non-volatile memory of the local resources in addition to allocated volatile memory, the storage application copies or moves the requested data from the allocated non-volatile memory to the allocated volatile memory if the requested data is not already available in the allocated volatile memory. In some embodiments, regardless of where the requested data is received, if the requested data is not already available in the allocated volatile memory, the storage application will receive, in the allocation of volatile memory, the requested data in response to the requested data being unavailable in the allocation of volatile memory.

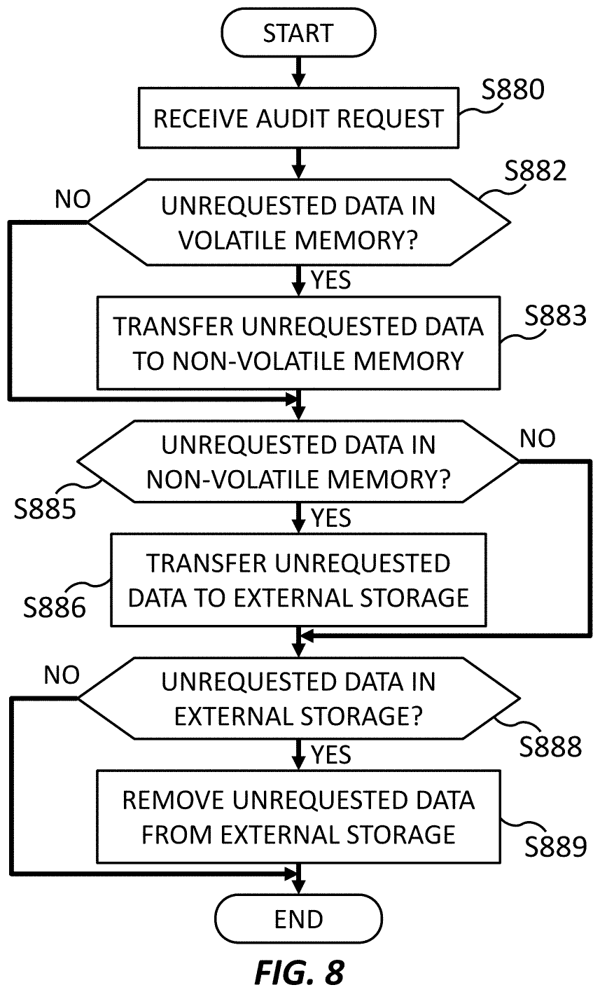

FIG. 8 is an operational flow for unrequested data removal, according to at least embodiment of the present invention. In some embodiments, the operational flow provides a method of unrequested data removal by a storage application of a storage virtualization in a storage layer of a host server. The storage application includes an allocation of local resources of the host server. The allocation of local resources includes at least an allocation of volatile memory and an allocation of non-volatile memory. Unrequested data is data of content that has not been requested for a designated amount of time. In some embodiments, the designated amount varies based on the type of storage, in that types of storage that require more energy consumption have smaller designated amounts of time than types of storage requiring less energy consumption.

At S880, the storage application receives an audit request to check for unrequested data stored in the instance of storage virtualization running the storage application. For example, in some embodiments, an audit request is self-initiated, received from the storage layer or another layer in the host server, or received from an apparatus in communication with the host server. In some embodiments, the audit request is in response to an event, an amount of time elapsing since the previous audit, etc. Receiving the audit request initiates the operational flow of FIG. 8.

At S882, the storage application determines whether the allocated volatile memory of the instance of storage virtualization running the storage application is currently storing any unrequested data. For example, in some embodiments, the storage application reads content headers to consider the last time the content was requested, and determine whether the last time the content was requested is before or after a cut-off time. In some embodiments, content stored in volatile memory has a small designated amount of time to go unrequested, such as two hours. If there is any unrequested data currently stored in the allocated volatile memory, then operational flow proceeds to S883, where the unrequested data is removed. If there is not any unrequested data currently stored in the allocated volatile memory, then operational flow proceeds to S885, without data removal.

At S883, the storage application transfers the unrequested data from the allocated volatile memory to the allocated non-volatile memory. For example, in some embodiments, the storage application may copies the unrequested data to the allocated non-volatile memory, and then removes the unrequested data from the allocated volatile memory. This will effectively transfer the unrequested data from the allocation of volatile memory to the allocation of non-volatile memory. In some embodiments, when data is first retrieved by the instance of storage virtualization, the storage application stores copies of the data in both the allocated volatile memory and the allocated non-volatile memory. In such embodiment, unrequested data is simply removed from the volatile memory while maintaining the copy in the allocated non-volatile memory.

At S885, the storage application determines whether the allocated non-volatile memory of the instance of storage virtualization running the storage application is currently storing any unrequested data. For example, in some embodiments, the storage application reads content headers to consider the last date and time the content was requested, and determine whether the last date and time the content was requested is before or after a cut-off date and time. In some embodiments, content stored in non-volatile memory has a larger designated amount of time to go unrequested than the volatile memory, such as seven days. If there is any unrequested data currently stored in the allocated non-volatile memory, then operational flow proceeds to S886, where the unrequested data is removed. If there is not any unrequested data currently stored in the allocated non-volatile memory, then operational flow proceeds to S888, without data removal.

At S886, the storage application transfers the unrequested data from the allocated non-volatile memory to an external storage in communication with the host server. For example, in some embodiments, the storage application copies the unrequested data to the external storage, and then removes the unrequested data from the allocated non-volatile memory. This will effectively transfer the unrequested data from the allocated local resources to the external storage. In some embodiments, the transfer is scheduled to be performed at night or other off-peak time.

At S888, the storage application determines whether the external storage is currently storing any unrequested data. For example, in some embodiments, the storage application reads content headers to consider the last date and time the content was requested, and determines whether the last date and time the content was requested is before or after a cut-off date and time. In some embodiments, content stored in external storage has the largest designated amount of time to go unrequested, such as thirty days. If there is any unrequested data currently stored in the external storage, then operational flow proceeds to S889, where the unrequested data is removed. If there is not any unrequested data currently stored in the external storage, then operational flow ends, without data removal.

At S889, the storage application removes the unrequested data from the external storage in communication with the host server. For example, once the unrequested data is removed from the external storage, the data must be retrieved from an origin device upon further request.

In some embodiments, there are three levels of data: hot data, which is currently being accessed, or has been accessed in the last two hours, and is stored in allocated volatile memory; warm data, which has been accessed within the last seven days, and is stored in allocated non-volatile memory; and cold data, which has been accessed within the last thirty days, and is stored in external storage. In some embodiments, different designations of time are assigned, and the designations of time depend on factors other than or in addition to time.

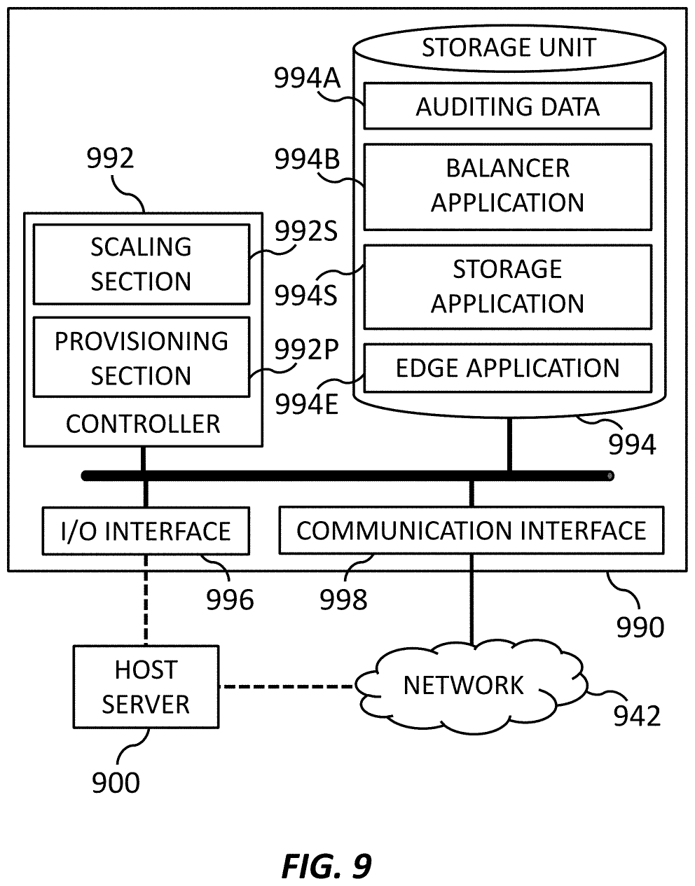

FIG. 9 is a block diagram of an exemplary hardware configuration for scalable content delivery resource usage, according to at least one embodiment of the present invention. The exemplary hardware configuration includes apparatus 990, which communicates with network 942, and interacts with host server 900. Apparatus 990 may be a client computer that connects directly to host server 900, or indirectly through network 942. In some embodiments, apparatus 990 is a computer system that includes two or more computers. In some embodiments, apparatus 990 is a personal computer that executes an application for a user of apparatus 990.

Apparatus 990 includes a controller 992, a storage unit 994, a communication interface 998, and an input/output interface 996. In some embodiments, controller 992 includes a processor or programmable circuitry executing instructions to cause the processor or programmable circuitry to perform operations according to the instructions. In some embodiments, controller 992 includes analog or digital programmable circuitry, or any combination thereof. In some embodiments, controller 992 includes physically separated storage or circuitry that interacts through communication. In some embodiments, storage unit 994 includes a non-volatile computer-readable medium capable of storing executable and non-executable data for access by controller 992 during execution of the instructions. Communication interface 998 transmits and receives data from network 942. Input/output interface 996 connects to various input and output units via a parallel port, a serial port, a keyboard port, a mouse port, a monitor port, and the like to accept commands and present information.

Controller 992 includes provisioning section 992P and scaling section 992S. Storage unit 994 includes edge application 994E, storage application 994S, balancer application 994B, and auditing data 994A.

Provisioning section 992P is the circuitry or instructions of controller 992 that provisions instances of virtualization on host server 900. For example, in some embodiments, provisioning section 992P is configured to provision instances of edge virtualizations in an edge layer, instances of balancer virtualization in a balancer layer, and instances of storage virtualizations in a storage layer. Provisioning section 992P may utilize information in storage unit 992, such as edge application 994E, storage application 994S, balancer application 994B, each of which includes the code for the respective application in source or compiled format. In some embodiments, provisioning section 992P includes sub-sections for performing additional functions, as described in the foregoing flow charts. Such sub-sections may be referred to by a name associated with their function.

Scaling section 992S is the circuitry or instructions of controller 992 that performs audits and scales instances of virtualization. For example, in some embodiments, scaling section 992S is configured to check for excessive requests, stored data, and virtualizations, and request addition or removal of virtualizations accordingly. In some embodiments, while performing audits, scaling section 992S accesses auditing data 994A, which includes proportions, designated times, etc. In some embodiments, scaling section 992S includes sub-sections for performing additional functions, as described in the foregoing flow charts. In some embodiments, such sub-sections are referred to by a name associated with the corresponding function.

In some embodiments, the apparatus is another device capable of processing logical functions in order to perform the operations herein. The controller and the storage unit need not be entirely separate devices, but share circuitry or one or more computer-readable mediums in some embodiments. For example, in some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In some embodiments where the apparatus is a computer, a program that is installed in the computer is capable of causing the computer to function as or perform operations associated with apparatuses of the embodiments described herein. In some embodiments, such a program is executable by a processor to cause the computer to perform certain operations associated with some or all of the blocks of flowcharts and block diagrams described herein.

Various embodiments of the present invention are described with reference to flowcharts and block diagrams whose blocks may represent (1) steps of processes in which operations are performed or (2) sections of a controller responsible for performing operations. Certain steps and sections are implemented by dedicated circuitry, programmable circuitry supplied with computer-readable instructions stored on computer-readable media, and/or processors supplied with computer-readable instructions stored on computer-readable media. In some embodiments, dedicated circuitry includes digital and/or analog hardware circuits and may include integrated circuits (IC) and/or discrete circuits. In some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Various embodiments of the present invention include a system, a method, and/or a computer program product. In some embodiments, the computer program product includes a computer readable storage medium (or media) having computer readable program instructions thereon for causing a processor to carry out aspects of the present invention.

In some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein are downloadable to respective computing/processing devices from a computer readable storage medium or to an external computer or external storage device via a network, for example, the Internet, a local area network, a wide area network and/or a wireless network. In some embodiments, the network may includes copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, the computer readable program instructions are executed entirely on the user's computer, partly on the user's computer, as a stand-alone software package, partly on the user's computer and partly on a remote computer or entirely on the remote computer or server. In some embodiments, in the latter scenario, the remote computer is connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. It will be apparent to persons skilled in the art that various alterations and improvements can be added to the above-described embodiments. It will also be apparent from the scope of the claims that the embodiments added with such alterations or improvements are included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the processes must be performed in this order.

According to at least one embodiment of the present invention, scalable content delivery resource usage is implemented through a computer-readable medium that includes instructions that are executable by a computer to cause the computer to perform operations including provisioning an initial edge virtualization among a plurality of edge virtualizations, each edge virtualization of the plurality of edge virtualizations provisioned with an allocation of local resources and an edge application. The edge application is configured to receive data requests from at least one device, retrieve requested data from a plurality of storage virtualizations, and transmit the requested data to the at least one device. The operations further include provisioning an additional edge virtualization among the plurality of edge virtualizations in response to an increase in concurrent data requests. The operations may further include provisioning an initial storage virtualization among the plurality of storage virtualizations, each storage virtualization of the plurality of storage virtualizations provisioned with an allocation of the local resources and a storage application. The storage application is configured to receive the data requests from the plurality of edge virtualizations, receive, in the allocation of the local resources, the requested data from an origin device in response to the requested data being unavailable on the local resources, and remove unrequested data from the allocation of the local resources, the unrequested data being data that has not been requested for a period of time. The operations further include provisioning an additional storage virtualization among the plurality of storage virtualizations in response to an increase in data on the local resources.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions that are executable by a computer to cause the computer to perform operations comprising:
provisioning an initial edge virtualization among a plurality of edge virtualizations, each edge virtualization of the plurality of edge virtualizations provisioned with an allocation of local resources and an edge application configured to:
receive data requests from at least one device,
retrieve requested data from a plurality of storage virtualizations, and
transmit the requested data to the at least one device;
provisioning an additional edge virtualization among the plurality of edge virtualizations in response to an increase in concurrent data requests;
provisioning an initial storage virtualization among the plurality of storage virtualizations, each storage virtualization of the plurality of storage virtualizations provisioned with an allocation of the local resources and a storage application configured to:
receive the data requests from the plurality of edge virtualizations,
receive, in the allocation of the local resources, the requested data from an origin device in response to the requested data being unavailable on the local resources, and
remove unrequested data from the allocation of the local resources, the unrequested data being data that has not been requested for a period of time; and
provisioning an additional storage virtualization among the plurality of storage virtualizations in response to an increase in data on the local resources.

2. The computer-readable medium of claim 1, further comprising provisioning one or more additional edge virtualizations among the plurality of edge virtualizations so that a number of edge virtualizations among the plurality of edge virtualizations is proportional to a number of concurrent data requests.

3. The computer-readable medium of claim 1, further comprising removing one or more edge virtualizations among the plurality of edge virtualizations until a number of edge virtualizations among the plurality of edge virtualizations is proportional to a number of concurrent data requests.

4. The computer-readable medium of claim 1, further comprising provisioning one or more additional storage virtualizations among the plurality of storage virtualizations so that a number of storage virtualizations among the plurality of storage virtualizations is proportional to an amount of data stored in the local resources.

5. The computer-readable medium of claim 1, further comprising removing one or more storage virtualizations among the plurality of storage virtualizations until a number of storage virtualizations among the plurality of storage virtualizations is proportional to an amount of data stored in the local resources.

6. The computer-readable medium of claim 1, wherein each allocation of local resources includes a portion of computational resources of a host server.

7. The computer-readable medium of claim 6, wherein each virtualization among the plurality of edge virtualizations and the plurality of storage virtualizations shares a kernel of the host server.

8. The computer-readable medium of claim 1, wherein the operations further comprise provisioning a balancer virtualization with an allocation of local resources and a balancer application configured to direct communication between the plurality of edge virtualizations and the plurality of storage virtualizations.

9. The computer-readable medium of claim 1, wherein the storage application is further configured to
transfer the unrequested data from the allocation of the local resources to an external storage, and
receive, in the allocated local resources, the requested data from the external storage in response to the requested data being unavailable on the local resources and available in the external storage.

10. The computer-readable medium of claim 1, wherein
the allocation of local resources includes an allocation of volatile memory and an allocation of non-volatile memory.
the storage application is further configured to
receive, in the allocated volatile memory, the requested data in response to the requested data being unavailable in the allocated volatile memory, and
transfer the unrequested data from the allocated volatile memory to the allocated non-volatile memory.

11. A method comprising:
provisioning an initial edge virtualization among a plurality of edge virtualizations, each edge virtualization of the plurality of edge virtualizations provisioned with an allocation of local resources and an edge application configured to:
receive data requests from at least one device,
retrieve requested data from a plurality of storage virtualizations, and
transmit the requested data to the at least one device;
provisioning an additional edge virtualization among the plurality of edge virtualizations in response to an increase in concurrent data requests;
provisioning an initial storage virtualization among the plurality of storage virtualizations, each storage virtualization of the plurality of storage virtualizations provisioned with an allocation of the local resources and a storage application configured to:
receive the data requests from the plurality of edge virtualizations,
receive, in the allocation of the local resources, the requested data from an origin device in response to the requested data being unavailable on the local resources, and
remove unrequested data from the allocation of the local resources, the unrequested data being data that has not been requested for a period of time; and
provisioning an additional storage virtualization among the plurality of storage virtualizations in response to an increase in data on the local resources.

12. The method of claim 11, further comprising provisioning one or more additional edge virtualizations among the plurality of edge virtualizations so that a number of edge virtualizations among the plurality of edge virtualizations is proportional to a number of concurrent data requests.

13. The method of claim 11, further comprising provisioning one or more additional storage virtualizations among the plurality of storage virtualizations so that a number of storage virtualizations among the plurality of storage virtualizations is proportional to an amount of data stored in the local resources.

14. The method of claim 11, wherein each allocation of local resources includes a portion of computational resources of a host server.

15. The method of claim 14, wherein each virtualization among the plurality of edge virtualizations and the plurality of storage virtualizations shares a kernel of the host server.

16. The method of claim 11, further comprising provisioning a balancer virtualization with an allocation of local resources and a balancer application configured to direct communication between the plurality of edge virtualizations and the plurality of storage virtualizations.

17. The method of claim 11, wherein the storage application is further configured to
transfer the unrequested data from the allocation of the local resources to an external storage, and
receive, in the allocated local resources, the requested data from the external storage in response to the requested data being unavailable on the local resources and available in the external storage.

18. The method of claim 11, wherein
the allocation of local resources includes an allocation of volatile memory and an allocation of non-volatile memory.
the storage application is further configured to
receive, in the allocated volatile memory, the requested data in response to the requested data being unavailable in the allocated volatile memory, and
transfer the unrequested data from the allocated volatile memory to the allocated non-volatile memory.

19. An apparatus comprising:
a controller including circuitry configured to
provision an initial edge virtualization among a plurality of edge virtualizations, each edge virtualization of the plurality of edge virtualizations provisioned with an allocation of local resources and an edge application configured to
receive data requests from at least one device,
retrieve requested data from a plurality of storage virtualizations, and
transmit the requested data to the at least one device,
provision an additional edge virtualization among the plurality of edge virtualizations in response to an increase in concurrent data requests,
provision an initial storage virtualization among the plurality of storage virtualizations, each storage virtualization of the plurality of storage virtualizations provisioned with an allocation of the local resources and a storage application configured to
receive the data requests from the plurality of edge virtualizations,
receive, in the allocation of the local resources, the requested data from an origin device in response to the requested data being unavailable on the local resources, and
remove unrequested data from the allocation of the local resources, the unrequested data being data that has not been requested for a period of time, and
provision an additional storage virtualization among the plurality of storage virtualizations in response to an increase in data on the local resources.

20. The apparatus of claim 19, wherein
each allocation of local resources includes a portion of computational resources of a host server; and
each virtualization among the plurality of edge virtualizations and the plurality of storage virtualizations shares a kernel of the host server.
